(19) United States
(12) Patent Application Publication
(10) Pub. No.: US 2005/0113261 A1
(43) Pub. Date: May 26, 2005

(54) Process for the preparation of a homogeneous, low-viscosity and long-term-stable polymer dispersion in mineral oils

(76) Inventors: Georg Huber, Traunreut (DE); Gregor Keilhofer, Tacherting (DE); Johann Plank, Trostberg (DE)

Correspondence Address: FULBRIGHT & JAWORSKI, LLP, 666 FIFTH AVE, NEW YORK, NY, 10103-3198, US

(21) Appl. No.: 10/959,597

(22) Filed: Oct. 6, 2004

(30) Foreign Application Priority Data
Oct. 9, 2003 (DE) DE 103 46 981.8

(51) Int. Cl. C09K 7/00; E21B 43/00

(52) U.S. Cl. 507/117; 507/219

(57) ABSTRACT

This process for the preparation of homogeneous, low-viscous and long-term-stable polymer dispersion in mineral oils, in which a liquid mineral oil component, to which a water-soluble polymer and an organophilic bentonite have been added, is stirred, is distinguished by the fact that the dispersing process is carried out at speeds of ≧1000 rpm. The duration of the stirring operation should preferably be between 5 and 60 minutes, and both aromatized and/or dearomatized mineral oils and also as typical water-soluble polymers, which moreover may have a maximum water content of 25% by weight, can be used. By means of this relatively simple process, homogeneous polymer-containing mineral oil dispersions having a low viscosity and at the same time pronounced long-term stability, which are suitable in particular for use in oil and gas exploration, are obtained in very short mixing times.

The present invention relates to a Process for the preparation of a homogeneous, low-viscosity and long-term-stable polymer dispersion in mineral oils.

Polymer-containing mineral oil dispersions are used in oil and gas exploration as additives to drilling mud and in the cementing of wells.

These dispersions are prepared in a manner that the liquid component in the form of aromatized and/or dearomatized mineral oils is provided in containers and optionally together with auxiliaries, such as surfactants or emulsifiers, and the water-soluble polymer to be dispersed, which may also be water-containing, is added.

In order to achieve the desired stability of the dispersion, as a rule an organophilic bentonite is added. In order to achieve the required stability and homogeneity of the dispersion, a relatively high viscosity of the dispersion of more than 1000 cp is required. This also avoids settling of the solids and so-called “sweating” of the dispersion However, the high viscosity is very disadvantageous for the handling property and the meterability of the suspension. Rather more desirable from the point of view of the user is a particularly low-viscosity suspension, which however exhibits no separation during storage.

In mineral oil-containing dispersions, organophilic bentonite can display contradictory and therefore also undesired properties: a high dose of the bentonite component brings about on the one hand the desired stability; on the other hand, the fluidity of the dispersion is, very greatly limited based on the high viscosity. However, this is not appropriate regarding the meterability and the pumpability at the drilling site. If, in contrast, the dosage of the bentonite component is chosen to be low, the fluidity is satisfactory in this case owing to the low viscosity, but these mixtures exhibit pronounced settling behavior and/or inhomogeneities. Accordingly, such dispersions have to be redispersed at the drilling site.

Usually, dispersions which were prepared with water-containing polymers and surfactants have an “apple purée-like” appearance in spite of long mixing times. Even the use of finely milled polymers allows this effect to occur. Some producers recommend the prehydration of the bentonite for shortening the mixing times, which, however, does not generally shorten the actual mixing time by much.

The use of polymers which were milled before dispersing likewise do not show a stabilizing effect on the dispersion.

On the basis of the known disadvantages of the prior art, it is therefore the object of the present invention to provide a process for the preparation of a homogeneous, low-viscosity and long-term-stable polymer dispersion in mineral oils by stirring a liquid mineral oil component to which a water-soluble polymer and an organophilic bentonite have been added, by means or which the desired dispersions are obtained in a simple and economic manner.

This object is achieved by a corresponding process in which, according to the invention, the dispersing process is carried out at speeds of ≧1000 rpm.

That the desired success: would actually be achieved with this process variant which appears to be relatively simple was not to be expected. At first glance, the object does not in fact appear to be achievable due to the described properties or organophilic bentonites which are used far stabilizing mineral oil dispersions, since they are known to exhibit contradictory behavior with regard to the viscosity and stability of the dispersion.

Surprisingly, by means of the process according to the invention and with the aid of the resulting brief use of a dispersing apparatus during the formulation, it was now possible to reduce the viscosity of the dispersion obtained substantially, while maintaining its long-term stability. Moreover, owing to the concomitant considerable shortening of the mixing and hydration time of the bentonite, a substantial increase on the space/-time yield could be achieved confirming the cost-efficiency of the process.

As was found in actual use, the desired properties of the polymer-containing mineral oils, namely a low viscosity and a high stability, can be best achieved if, in the preparation of the corresponding dispersions, a speed which is at least 1000 rpm and not more than 10 000 rpm is used. Preferably, the dispersing process is carried out at a speed of at least 1500 rpm, more preferably at least 2000 rpm and in particular at least 3000 rpm.

As already indicated, the decisive advantage of the process according to the invention is the high speeds during the preparation of the dispersions, which as a rule is also to be regarded independently of the duration of the stirring operation. Nevertheless, the preferred duration of the stirring operation in the present process is between 5 and 60 minutes and particularly preferably between 10 and 30 minutes.

Although the success of the claimed process is in principle independent of the type of mineral oil component used, particularly good success can be achieved if aromatized and/or dearomatized mineral oils such as, for example, Esso Exxsol D80 or Solvesso 100, are used.

Suitable water-soluble polymers in the context of the present invention are, for example, polysaccharides, such as guar, starch, cellulose or xanthan gum, which may also be derivatized, as well as synthetic polymers, such as the polyacrylates, homo- and copolymers, such as, for example, POLYDRILL®, i.e. polyacrylamides and vinyl sulfates or vinylamides.

Since. the success of the process according to the invention depends exclusively on the high speed, the further specification of the mineral oils and polymers used is not required since their composition and/or chemical character does not nave an adverse effect on the success of dispersing.

In some cases, it is preferable to specify the water content of the polymers, and it is for this reason that the invention includes a process variant in which the water-soluble polymer has a water content of not more than 25% by weight, water contents of between 1 and 15% by weight being regarded as particularly preferred.

Depending on the respective field of use of the dispersions prepared by the process according to the invention, auxiliaries, such as, for example, surfactants, emulsifiers, etc. and mixtures thereof, can also be added to the mineral oil component in the context of the present invention.

Since, for some organophilic bentonites, the producers thereof recommend use in the prehydrated state, the present invention likewise includes a process variation in which such prehydrated bentonites are used, with the result that the properties of the starting materials can be fully utilized.

According to the invention, the proportion of the liquid mineral oil component is preferably ≧20% by weight, in particular ≧30% by weight and more preferably ≧40% by weight and up to 95% by weight, in particular ≦90% by weight and more preferably ≦50% by weight. The proportion of water-soluble polymer is preferably ≧10% by weight, in particular ≧20% by weight and up to 60% by weight, in particular ≦50% by weight. The proportion of organophilic bentonite is preferably ≧1% by weight, in particular ≧2% by weight and up to 10% by weight, in particular ≦8% by weight. Auxiliaries may account for the remainder of the dispersion.

Finally, the present invention also provides a process in which a mixture which is composed of
from 40 to 90% by weight of a mineral oil,
from 10 to 60% by weight of a water-soluble polymer having a water content of up to 15% by weight,
up to 10% by weight of an organophilic bentonite and
from 0 to 10% by weight of an emulsifier as an auxiliary is dispersed.

Homogeneous dispersion, substantially consisting of a water-soluble polymer and mineral oils and having a sufficiently low viscosity of <1000 cP, preferably <800 cP and in particular ≦500 cP and at the same time having a pronounced long-term stability is obtained by the claimed dispersing operation at speeds between 1000 and not more than 10 000 rpm.

The dispersions according to the invention which are obtained in this manner are used in mineral oil and natural gas exploration, and there in particular as an additive to the drilling mud and for cementing of wells.

This process for the preparation of homogeneous, low-viscosity and long-term-stable polymer dispersion in mineral oils, into which a liquid mineral oil component, to which a water-soluble polymer and an organophilic bentenite have been added, is stirred, is distinguished by the fact that the dispersing process is carried out at speeds of ≧1000 rpm. The duration of the stirring operation should preferably be between 5 and 60 minutes, and both aromatized and/or dearomatized mineral oils and also typical water-soluble polymers, which moreover may have a maximum water content of 25% by weight, can be used. By means of this relatively simple process, homogeneous polymer-containing mineral oil dispersions having a low viscosity and at the same time pronounced long-term stability, which are suitable in particular for use in oil and gas exploration, are obtained in very short mixing times.

The following examples illustrate in particular the economic advantages of this process according to the invention.

### EXAMPLES

Starting Materials:
51% by weight of mineral oil (“Exxsol D80” from Esso AG)
40% by weight of water-soluble polymer (“POLYDRILL®” from Degussa Construction Polymers GmbH; water content: 8% by weight)
5% by weight of emulsifier (“TEGO SML 20” from Goldschmidt AG)
4% by weight of organophilic bentonite (“Tixogel® VP” from Südchemie AG)

The liquid components (mineral oil, emulsifier) were provided in a stirred container at 23° C. Various stirrers were used for mixing, and the results were compared. In the procedure used, first the polymer is added and then the bentonite is metered in in portions. Optionally, the mixtures were cooled.

The mixing times with the conventional stirrers used in comparative examples 1 to 4 was in each case 12 hours. The mixing time of example 5 of the invention was about 10 minutes using an ULTRA TURRAX® from IKA® company.

In comparative examples 2 and 4, prehydrated bentonite (“Tixogel VP” from Südchemie AG) and/or a milled polymer (“POLYDRILL®” from Degussa Construction polymers GmbH) was used. In example 5 of the invention, as well as in examples 1 and 3, these components remained untreated.

| | | | Viscosity | Settling | |
|---|---|---|---|---|---|
| | | | of the | behavior after | |
| Ex. | | Speed | prepared | hours | |
| No.: | Stirrer | [rpm] | dispersion | (supernatant) | Appearance |
| 1 | Paddle | 500 | 3000 cP | 10% after 24 h | inhomo- |
| | stirrer | | | | geneous |
| 2 | Warring | 600 | 3000 cP | 10% after 24 h | inhomo- |
| | Blendor | | | | geneous |
| 3 | Warring | 600 | 3200 cP | 14% after 36 h | inhomo- |
| | Blendor | | | | geneous |
| 4 | Warring | 600 | 2900 cP | 13% after 36 h | “apple |
| | Blendor | | | | purée- |
| | | | | | like” |
| 5 | ULTRA- | 1500 | 500 cP | 1% after 72 h | homo- |
| | TURRAX ® | | | | geneous, |
| | | | | | flowable, |
| | | | | | stable |
| | | | | | (>30 d) |

These examples clearly show the superiority of the present invention: in the case of mixtures No. 1 to 4, which were prepared according to the prior art to date, a dispersion of higher viscosity (about 3000 cP) and moderate stability results. Example No. 5, prepared according to the present invention, combines a substantially lower viscosity with greatly optimized stability of the dispersion. For the user, this means a considerable improvement in terms of better pumpability and meterability on the one hand and a longer shelf life on the other hand.

1. A process for the preparation of a homogeneous, low-viscous and long-term-stable polymer dispersion in a mineral oil, comprising stirring a liquid mineral oil component to which a water-soluble polymer and an organophilic bentonite have been added, at speeds of ≧1000 rpm to form the dispersion of water-soluble polymer and organophilic bentonite in oil.

2. The process as claimed in claim 1, wherein the speed is not more than 10,000 rpm.

3. The process as claimed in claim 1, wherein the duration of the stirring operation is from 5 to 60 minutes.

4. The process as claimed in claim 1, wherein said mineral oil is an aromatized or dearomatized mineral oils.

5. The process as claimed in claim 1, wherein said water-soluble polymer is selected from the group consisting of a polysaccharide and a synthetic polymer.

6. The process as claimed in claim 1, wherein the water-soluble polymer has a water content of not more than 25% by weight.

7. The process as claimed in claim 1, further comprising adding at least one of an auxiliary selected from the group consisting of a surfactant and an emulsifier to the mineral oil.

8. The process as claimed in claim 1, wherein the organophilic bentonite is in the prehydrated state.

9. The process as claimed in claim 1, wherein a mixture having the dispersion comprises:
from 40 to 90% by weight of mineral oil,
from 10 to 60% by weight of water-soluble polymer having a water content of up to 15% by weight,
from 1 to 10% by weight of organophilic bentonite; and
from 0 to 10% by weight of an auxiliary.

10. A drilling mud comprising the dispersion prepared by the method of claim 1 and a drilling mud component.

11. The method of claim 4, wherein said mineral oil is selected from the group consisting of Esso Exxsol D80 and Solvesso 100.

12. The method of claim 5, wherein said polysaccharide is a derivatized polysaccharide.

13. The method of claim 5, wherein said synthetic polymer is a polyacrylate, a homopolymer or a copolymer.

14. The method of claim 6, wherein the water-soluble polymer has a water content between 1 and 15% by weight.

15. The process of claim 7, wherein said auxiliary is selected from the group consisting of Tego SML 20 and Genapol X 050.

16. The process of claim 9, wherein said auxiliary is an emulsifier.
